(19) United States
(12) Patent Application Publication
(10) Pub. No.: US 2019/0369656 A1
(43) Pub. Date: Dec. 5, 2019

(54) Smart Overclocking Method

(71) Applicant: TAI-SHENG HAN, New Taipei (TW)

(72) Inventor: TAI-SHENG HAN, New Taipei (TW)

(21) Appl. No.: 16/058,882

(22) Filed: Aug. 8, 2018

(30) Foreign Application Priority Data
May 31, 2018 (TW) 107118774

(51) Int. Cl. G06F 1/08; G06F 9/4401; G06F 11/34; G06F 11/22; G06F 11/07

(52) U.S. Cl. CPC G06F 1/08; G06F 9/4403; G06F 11/0754; G06F 11/2242; G06F 11/2284; G06F 11/3433

(57) ABSTRACT

The present invention provides a smart overclocking method which comprises: providing a computer device with a multi-core CPU and building an overclocking database in a BIOS of the computer device; booting the computer device and logging in the BIOS and performing an overclocking function; acquiring overclocking numerical data in the overclocking database; performing adjustment of the frequency and the voltage of the multi-core CPU on the multi-core CPU with the overclocking numerical data; performing a heavy load pressure test on the multi-core CPU; reading in real time the working frequency, the working voltage, and the working temperature of the multi-core CPU and determining whether they have exceeded limits. Hence, after a user performs an overclocking function, a BIOS unit performs an overclocking test and determines the working frequency, the working voltage, and the working temperature, thereby achieving the efficacy that the BIOS unit can offer the optimized proposals for overclocking.

### BACKGROUND OF THE INVENTION

### 1. Field of the Invention

The present invention relates to a smart overclocking method, in which a basic input/output system (BIOS) unit can automatically evaluate a thermal dissipation environment of a multi-core central processing unit (CPU) and offer one of the optimal proposals for overclocking.

### 2. Description of the Related Art

When an electronic component in a computer system is delivered, a standard working range is generally defined for the electronic component. Overclocking is a technology capable of increasing the clock speed of an electronic component, with which a working range of the electronic component can exceed the standard working range defined by a manufacturer. Moreover, in order to operate in a safest and most stable condition, a computer system controls, mainly by a BIOS of a computer, various electronic components of the computer, such that the electronic components all are in standard working ranges defined by manufacturers. However, for a user, overclocking can improve the performance of an electronic component, thereby achieve cost-effectiveness. In addition, when a working range of the electronic component expands, the performance of the computer system also is accordingly improved. Thus, many users expect to overclock working frequency of the electronic component to the optimal value, such that the computer system can obtain better performance. Many methods for overclocking have already been known, in which a software is used to perform overclocking on a computer system, and the use of the software can be further divided as setting in a set mode of a BIOS or performing dynamic overclocking on an operating system. When overclocking is performed in the BIOS, a user needs to log in the BIOS while booting the computer system, so as to make self-adjustment on relevant setting parameters, and the BIOS would record this set of setting parameters before crashing. When the user reboots the computer system, the computer system operates according to this set of setting parameters, and the user can readjust these setting parameters according to this set of setting parameters recorded in the BIOS. The setting parameters can then be adjusted to the optimized ones after constant attempts and mistakes as well as a series of operational settings. Although the optimized parameters can be achieved through adjustment, such a method for overclocking needs longtime accumulation of experiences to perform constant calculations and tests, which is rather difficult for a user that is not familiar with the computer system. Furthermore, during overclocking, constant exceeding of the highest working range would resulting in certain damage to respective electrical components and doubts about security.

Therefore, how to solve the existing problems and deficiencies described above represents a direction of research and improvement by the present inventors and relevant manufacturers in the art.

### SUMMARY OF THE INVENTION

Hence, in order to effectively solve above problems, a main objective of the present invention is to provide a smart overclocking method, in which a BIOS unit can automatically evaluate a thermal dissipation environment of a multi-core CPU and offer one of the optimal proposals for overclocking.

In order to achieve the above objectives, provided in the present invention is a smart overclocking method. The method comprises: providing a computer device with a multi-core CPU and building an overclocking database in a BIOS of the computer device; booting the computer device and logging in a setting image of the BIOS and performing an overclocking function; acquiring, according to a model of the multi-core CPU, overclocking numerical data in the overclocking database; performing adjustment of the working frequency and the working voltage on the multi-core CPU with the overclocking numerical data; performing a heavy load pressure test on the multi-core CPU; reading the working frequency, the working voltage, and the working temperature of the multi-core CPU and determining whether they have exceeded limits; if beyond the limits, reducing the working frequency and the working voltage of the overclocking numerical data, and revealing the overclocking numerical data; and if not beyond the limits, retrieving, by an adjustment module, other overclocking numerical data to adjust the working frequency and the working voltage. Hence, the smart overclocking method achieves the efficacy that the BIOS unit can automatically evaluate a thermal dissipation environment of the multi-core CPU and offer the optimized proposals for overclocking.

### BRIEF DESCRIPTION OF THE DRAWINGS

FIG. 1 is a first flow chart of the preferred embodiment of the present invention.

FIG. 2 is a first block schematic view of the preferred embodiment of the present invention.

FIG. 3 is a second flow chart of the preferred embodiment of the present invention.

FIG. 4 is a second block schematic view of the preferred embodiment of the present invention.

### DETAILED DESCRIPTION OF THE PREFERRED EMBODIMENTS

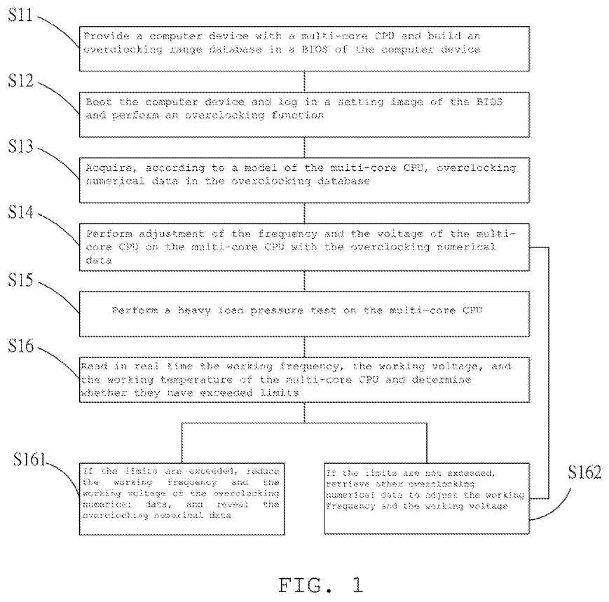

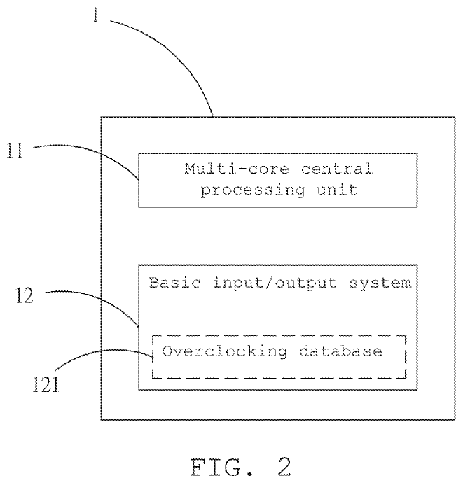

Referring to FIGS. 1 and 2, a first flow chart and a block schematic view of a preferred embodiment of the present invention are shown, and it can be clearly seen from the figures that a smart overclocking method comprises:

Step S11: providing a computer device with a multi-core CPU and building an overclocking database in a BIOS of the computer device; wherein, above all, a computer device 1 is provided first, the computer device 1 has a multi-core CPU 11, and the computer device 1 has a BIOS 12, and an overclocking database 121 is built in the BIOS 12, the overclocking database 121 has multiple overclocking numerical data, and respective overclocking numerical data correspond to different models of multi-core CPUs 11, and the overclocking numerical data are secure overclocking numerical values and stable overclocking voltage numerical values, that is, different multi-core CPUs 11 have different most preferred overclocking numerical values, and respective multi-core CPU 11 has corresponding overclocking numerical data, while respective overclocking numerical data define working frequency and working voltage thereof, in addition, every core in every multi-core CPU 11 has different operational efficacy, and even with a same number of core units, different models of multi-core CPUs 11 can also correspond to the different highest overclocking levels.

Step S12: booting the computer device and logging in a setting image of the BIOS and performing an overclocking function; the computer device 11 is booted and the BIOS 12 is logged in, the BIOS 12 would produce a setting image, and a function of conducting automatic overclocking is performed in the setting image.

Step S13: acquiring, according to the model of the multi-core CPU, the overclocking numerical data in the overclocking database; the computer device 1 would first read the model of the multi-core CPU 11, then according to which, the overclocking numerical data in the overclocking database 121 is retrieved, and the overclocking numerical data corresponding to the model of the core CPU is acquired, while the corresponding overclocking numerical data would define the working frequency and the working voltage.

Step S14: performing adjustment of the frequency and the voltage of the multi-core CPU on the multi-core CPU with the overclocking numerical data; the working frequency and the working voltage defined by the corresponding overclocking numerical data are used as a benchmark, and the working frequency and the working voltage of the multi-core CPU 11 are then adjusted, which are adjusted to the working frequency and the working voltage defined by the overclocking numerical data.

Step S15: performing a heavy load pressure test on the multi-core CPU; a heavy load test is performed on the multi-core CPU 11 with the working frequency and the working voltage defined by the overclocking numerical data, such that the multi-core CPU 11 performs a heavy load operation with a peripheral device of the computer device 1.

Step S16: reading in real time the working frequency, the working voltage, and the working temperature of the multi-core CPU and determining whether they have exceeded limits or not; after the heavy load pressure test, the working frequency, the working voltage, and the working temperature of the multi-core CPU 11 presented under the heavy load pressure test are read, and a determination whether the working frequency, the working voltage, and the working temperature have exceeded the maximum frequency limit, the maximum voltage limit, and the maximum temperature limit of the multi-core CPU 11 is made.

Step S161: if beyond the limits, reducing the working frequency and the working voltage of the overclocking numerical data, and revealing the overclocking numerical data; if a determination is made that the working frequency, the working voltage, and the working temperature of the multi-core CPU 11 presented after the heavy load test have exceeded the maximum frequency limit, the maximum voltage limit, and the maximum temperature limit of the multi-core CPU 11, then an action of order reduction is performed with the working frequency and the working voltage of the overclocking numerical data as the benchmark, and the overclocking numerical data of the working frequency and the working voltage after the order reduction is revealed on the BIOS 12, which is available for a user to choose whether to adopt the overclocking numerical data after the order reduction and to end the function of automatic overclocking.

Step S162: if not beyond the limits, retrieving other overclocking numerical data to adjust the working frequency and the working voltage; if a determination is made that the working frequency, the working voltage, and the working temperature of the multi-core CPU 11 presented after the heavy load test have not exceeded the maximum frequency limit, the maximum voltage limit, and the maximum temperature limit of the multi-core CPU 11, that is to say, the overclocking numerical data thereof cannot achieve the optimized overclocking effect, then the working frequency and the working voltage defined by the other overclocking numerical data is retrieved to perform adjustment, and the working frequency and the working voltage defined by the corresponding overclocking numerical data are used as a benchmark, and the working frequency and the working voltage of the multi-core CPU 11 are then adjusted, which are adjusted to the working frequency and the working voltage defined by the overclocking numerical data, and a heavy load test is performed on the multi-core CPU 11 with the working frequency and the working voltage defined by the overclocking numerical data, such that the multi-core CPU 11 performs a heavy load operation with a peripheral device of the computer device 1, and the working frequency, the working voltage, and the working temperature of the multi-core CPU 11 presented under the heavy load pressure test are read, and a determination whether the working frequency, the working voltage, and the working temperature have exceeded the maximum frequency limit, the maximum voltage limit, and the maximum temperature limit of the multi-core CPU 11 is made, until the working frequency, the working voltage, and the working temperature presented have exceeded the maximum frequency limit, the maximum voltage limit, and the maximum temperature limit of the multi-core CPU 11, then a user is allowed to choose whether to adopt the overclocking numerical data after the order reduction and to end the function of automatic overclocking, thereby, the smart overclocking method achieves the efficacy of automatic evaluation of a thermal dissipation environment and offer of the optimized proposal for overclocking.

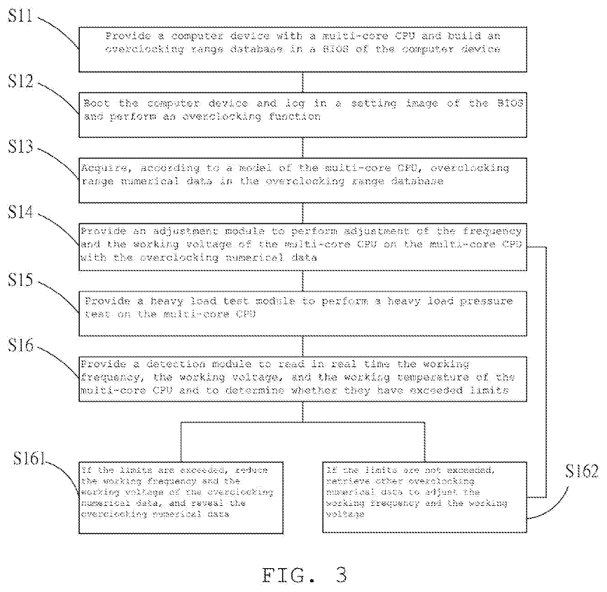

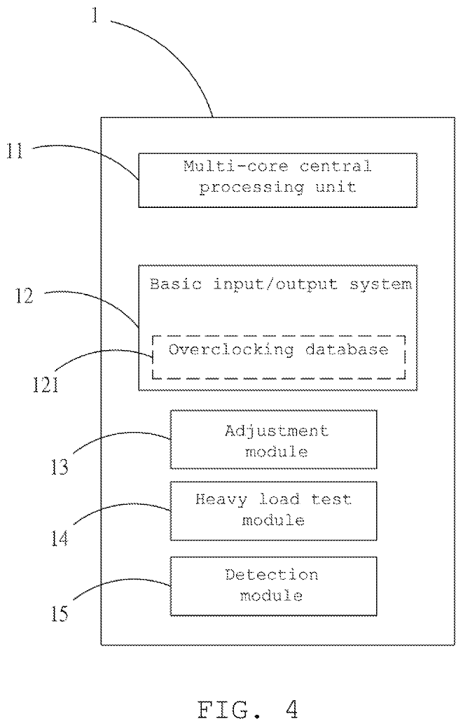

Referring to both FIG. 3 and FIG. 4, a second flow chart and a second block schematic view of the preferred embodiment of the present invention is shown, and it can be clearly seen from the drawings that a smart overclocking method provides an adjustment module 13, a heavy load test module 14, and a detection module 15, wherein the adjustment module 13, the heavy load test module 14, and the detection module 15 are disposed in the computer device 1, and as for Step S11 to Step S16, the Step S14: performing, by the adjustment module, adjustment of the frequency and the voltage of the multi-core CPU on the multi-core CPU with the overclocking numerical data; wherein, the adjustment module 13 performs adjustment of the frequency and the voltage of the multi-core CPU 11 on the multi-core CPU 11 with the overclocking numerical data, and wherein the adjustment module 13 adjusts the working frequency and the working voltage of all cores of the multi-core CPU 11, and through the adjustment module 13, the working frequency and the working voltage defined by the corresponding overclocking numerical data are used as a benchmark, and the working frequency and the working voltage of the multi-core CPU 11 are then adjusted, which are adjusted to the working frequency and the working voltage defined by the overclocking numerical data, moreover, the Step S15: performing, by the heavy load test module, a heavy load pressure test on the multi-core CPU; and the heavy load test module 14 performs a heavy load test on the multi-core CPU 11 with the working frequency and the working voltage defined by the overclocking numerical data, and the heavy load test module 14 performs the heavy load test on all cores of the multi-core CPU 11, such that the multi-core CPU 11 performs a heavy load operation with a peripheral device of the computer device 1, furthermore, the Step S16: reading, by the detection module, in real time the working frequency, the working voltage, and the working temperature of the multi-core CPU and determining whether they have exceeded limits; and the detection module 15 reads in real time the working frequency, the working voltage, and the working temperature of the multi-core CPU 11 presented under the heavy load pressure test, and determines whether the working frequency, the working voltage, and the working temperature have exceeded the maximum frequency limit, the maximum voltage limit, and the maximum temperature limit of the multi-core CPU 11, and the detection module 15 detects the working frequency, the working voltage, and the working temperature of all cores of the multi-core CPU 11, if not beyond the limits, the adjustment module 13 retrieves other overclocking numerical data to adjust the working frequency and the working voltage, thereby, the smart overclocking method achieves the efficacy that a BIOS unit can automatically evaluate a thermal dissipation environment of a multi-core CPU and offer the optimized proposals for overclocking.

It should be set forth that, the above description is merely the preferred embodiment of the present invention, and is not intended to limit the present invention, and without departing from the spirit and scope of the present invention, all changes made according to the inventive concept should fall within the scope of the claims which follow, such as changes of the type of configuration and arrangements, equivalent effects due to all kinds of changes, modifications, and applications, as is set forth above.

What is claimed is:

1. A smart overclocking method, comprising:
providing a computer device with a multi-core CPU and building an overclocking database in a basic input/output system of the computer device;
booting the computer device and logging in a setting image of the basic input/output system and performing an overclocking function;
acquiring, according to a model of the multi-core CPU, overclocking numerical data in the overclocking database;
performing adjustment of the frequency and the voltage of the multi-core CPU on the multi-core CPU with the overclocking numerical data;
performing a heavy load pressure test on the multi-core CPU;
reading in real time the working frequency, the working voltage, and the working temperature of the multi-core CPU and determining whether they have exceeded limits or not;
if beyond the limits, reducing the working frequency and the working voltage of the overclocking numerical data, and revealing the overclocking numerical data;
and if not beyond the limits, retrieving other overclocking numerical data to adjust the working frequency and the working voltage.

2. The smart overclocking method according to claim 1, wherein an adjustment module is provided to perform adjustment of the frequency and the voltage of the multi-core CPU on the multi-core CPU with the overclocking numerical data, and wherein the adjustment module adjusts the working frequency and the working voltage of all cores of the multi-core CPU.

3. The smart overclocking method according to claim 1, wherein a heavy load test module performs a heavy load pressure test on the multi-core CPU, and the heavy load test module performs a heavy load test on all cores of the multi-core CPU.

4. The smart overclocking method according to claim 1, wherein a detection module reads the working frequency, the working voltage, and the working temperature of the multi-core CPU and determines whether they have exceeded limits or not, and the detection module detects the working frequency, the working voltage, and the working temperature of all cores of the multi-core CPU.

5. The smart overclocking method according to claim 2, wherein if not beyond the limits, the adjustment module retrieves other overclocking numerical data to adjust the working frequency and the working voltage.

6. The smart overclocking method according to claim 1, wherein the overclocking database has the overclocking numerical data, and respective overclocking numerical data correspond to different multi-core CPUs, and the overclocking numerical data are secure overclocking numerical values and stable overclocking pressure numerical values.

7. The smart overclocking method according to claim 1, wherein the basic input/output system is referred to as BIOS.

8. The smart overclocking method according to claim 4, wherein the detection module reads the working frequency, the working voltage, and the working temperature of the multi-core CPU, and the detection module reads the working frequency, the working voltage, and the working temperature of the multi-core CPU presented under the heavy load pressure test, and determines whether the working frequency, the working voltage, and the working temperature have exceeded the maximum frequency limit, the maximum voltage limit, and the maximum temperature limit of the multi-core CPU.

9. The smart overclocking method according to claim 8, wherein if beyond the limits, the working frequency and the working volt age of the overclocking numerical data is reduced, and the revealed overclocking numerical data is revealed on the BIOS, and is available for a user to choose whether to adopt the overclocking numerical data.
